(19) United States
(12) Patent Application Publication
(10) Pub. No.: US 2025/0206200 A1
(43) Pub. Date: Jun. 26, 2025

(54) FOLD AND DIVE APPARATUS OF SEAT FOR VEHICLE

(71) Applicants: HYUNDAI MOTOR COMPANY, Seoul (KR); KIA CORPORATION, Seoul (KR); DAS CO., LTD, Gyeongju-si (KR)

(72) Inventors: Chan Ho JUNG, Gunpo-si (KR); Ho Suk JUNG, Hwaseong-si (KR); Sang Soo LEE, Hwaseong-si (KR); Hyun Kyu MOON, Incheon (KR); Dong Hoon KEUM, Busan (KR); Byung Yong CHOI, Hwaseong-si (KR); Deok Soo LIM, Hwaseong-si (KR); Mu Young KIM, Osan-si (KR); Jin Ho CHOI, Gyeongju-si (KR); Jae Youn KIM, Ulsan (KR)

(21) Appl. No.: 18/663,610

(22) Filed: May 14, 2024

(30) Foreign Application Priority Data
Dec. 20, 2023 (KR) 10-2023-0187232

(51) Int. Cl. B60N 2/12; B60N 2/02; B60N 2/64

(52) U.S. Cl. CPC B60N 2/12; B60N 2/02253; B60N 2/64

(57) ABSTRACT

A fold-and-dive apparatus according to an embodiment includes: a pair of bases installed on a vehicle and disposed to be spaced apart to the left and right; a pair of left and right cushion side frames connected to the pair of bases so that each position thereof is changeable; a back frame rotatably connected to the pair of cushion side frames via a recliner assembly at the rear of the pair of cushion side frames; a link assembly connecting the base and the cushion side frames at the rear of the pair of cushion side frames; a first driver connected to the link assembly to provide rotational force; and a locking assembly interposed between the back frame and the first driver, to restrict the operation of the first driver.

### CROSS-REFERENCE TO RELATED APPLICATION(S)

This application claims benefit of priority to Korean Patent Application No. 10-2023-0187232, filed on Dec. 20, 2023, in the Korean Intellectual Property Office, the disclosure of which is incorporated herein by reference in its entirety.

### TECHNICAL FIELD

The present disclosure relates to a fold-and-dive apparatus of a seat for a vehicle for improving safety and convenience of occupants by increasing flatness of a folded seat back.

### BACKGROUND

A seat for a vehicle may a seat cushion for seating a lower body, a seat back for leaning an upper body, and a headrest for supporting a head and neck. In some cases, the seat may further include various seat adjustment apparatuses, convenience apparatuses, and safety apparatuses that are installed inside and outside of the seat.

As an example of the safety apparatus, a bolster may be provided on the left and right sides of the seat cushion and seat back to support a side of an occupant when the vehicle turns or makes a sharp turn. Typically, the bolster is formed so that both side portions of the seat cushion or seat back partially protrude.

In some cases, in a vehicle with six or more seats, such as a sports utility vehicle (SUV), minivan, or the like, second-row seats may expand a cargo loading space by folding of a seatback thereof. However, in a case in which a protrusion of the bolster of the seat back increases in the second-row of seats, when the seat back is folded, the seat back does not be flat and is inclined, for example, at an angle exceeding 7 degrees with respect to a horizontal plane.

### SUMMARY

An aspect of the present disclosure is to provide a fold-and-dive apparatus of a seat for a vehicle for improving safety and convenience of occupants by increasing flatness of a folded seat back.

According to an aspect of the present disclosure, a fold-and-dive apparatus may include a pair of bases installed on a vehicle and disposed to be spaced apart to the left and right; a pair of left and right cushion side frames connected to the pair of bases so that each position thereof is changeable with respect to the base; a back frame rotatably connected to the pair of cushion side frames via a recliner assembly at the rear of the pair of cushion side frames; a link assembly connecting the base and the cushion side frame at the rear of the pair of cushion side frames; a first driver connected to the link assembly to provide rotational force; and a locking assembly interposed between the back frame and the first driver, to restrict the operation of the first driver.

The pair of cushion side frames may be connected to each other by at least one cross bar, both ends of the cross bar may penetrate each of the pair of cushion side frames and be coupled to the pair of cushion side frames to enable relative rotation, and one end of the cross bar may be fixedly coupled to an output shaft of the first driver.

The locking assembly may include a dive lock installed on one of the pair of cushion side frames to restrict the rotation of the cross bar; a releaser installed on a connection bracket of the one of the pair of cushion side frames, and connected to folding of the back frame to release dive locking of the dive lock; and a connection bar connecting the operation of the releaser and the operation of the dive locking.

The dive lock may include a dive holder fixedly coupled to the other end of the cross bar, and having a ratchet groove formed on a circumferential surface; a tooth bracket having a tooth-shaped portion formed on one side and a cam groove formed on the other side, and rotatably hinged to the pair of cushion side frames, the tooth-shaped portion being locked by the ratchet groove; a cam lever disposed to be adjacent to the tooth bracket on the opposite side of the tooth-shaped portion, rotatably hinged to the cushion side frame, and having a cam surface in contact with the tooth bracket; a pin plate rotatably assembled on the same hinge shaft as the cam lever, rotating with the cam lever, and having a connection pin formed on one side and hinged to one end of the connection bar; and a first spring having one end fixed to the other side of the pin plate and the other end fixed to the cushion side frame, wherein when the cam surface is inserted into the cam groove, the tooth-shaped portion may deviate from the ratchet groove.

The releaser may include a release lever rotatably hinged to the connection bracket, and having a connection pin formed on one side and hinged to the other end of the connection bar; a locking bracket hinged to the other side of the release lever, and having a locking pin formed on one side; and a second spring having one end fixed to the other side of the locking bracket, and the other end fixed to the connection bracket, wherein a hook may be fixedly mounted on a lower portion of the back frame, so that when the back frame rotates, the hook may be locked by the locking pin.

The link assembly may include a first link member and a second link member, one end of the first link member may be rotatably hinged to the cushion side frame, the other end of the first link member may be rotatably hinged to one end of the second link member relative to each other, and the other end of the second link member may be rotatably hinged to the base.

The first driver may include a first driving motor, a first gearbox connected to a motor shaft of the first driving motor, and the output shaft of the first gearbox, wherein the output shaft may be connected to one end of the first link member via the cross bar.

A second driver connected to the second link member to provide rotational force may be further included, and the second driver may be mounted on one of the pair of bases.

The second driver may include a second driving motor, a second gearbox connected to a motor shaft of the second driving motor, a connection shaft connected to the second gearbox, and a pair of cores respectively coupled to both ends of the connection shaft, wherein the connection shaft may be fixedly connected to the other end of the second link member via the core.

A link arm connecting the base and the cushion side frame may be further included at the front of the pair of cushion side frames, wherein the base, the link arm, the cushion side frame, the first link member, and the second link member may be hinged to each other, thereby forming a five-bar linkage mechanism.

One end of the link arm may be rotatably hinged to the cushion side frame, and the other end of the link arm may be rotatably hinged to the base, and at least one of hinge portions at both ends of the link arm may be provided with a return spring to help the link arm return after the rotation of the link arm.

The base may include a seat rail fixedly mounted on the vehicle, a moving rail mounted on the seat rail to slide back and forth in a longitudinal direction of the seat rail, and a bracket mounted on the moving rail, wherein a hinge hole or hinge portion for connecting the link assembly may be formed in the bracket.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a partial perspective view illustrating an example of a seat for a vehicle to which a fold-and-dive apparatus.

FIG. 2 is an exploded perspective view of the fold-and-dive apparatus.

FIG. 3 is a side view of FIG. 1 illustrating an example of a reference posture of an operation of the seat.

FIGS. 4 and 5 are diagrams illustrating an example of an operation of the fold-and-dive apparatus.

FIG. 6 is a side view illustrating an example state in which a seat back of the seat is folded by the fold-and-dive apparatus.

### DETAILED DESCRIPTION

Hereinafter, the present disclosure will be described in detail with reference to exemplary drawings. In adding reference numerals to components of each drawing, it should be noted that the same components are indicated by the same numerals even though displayed on different drawings.

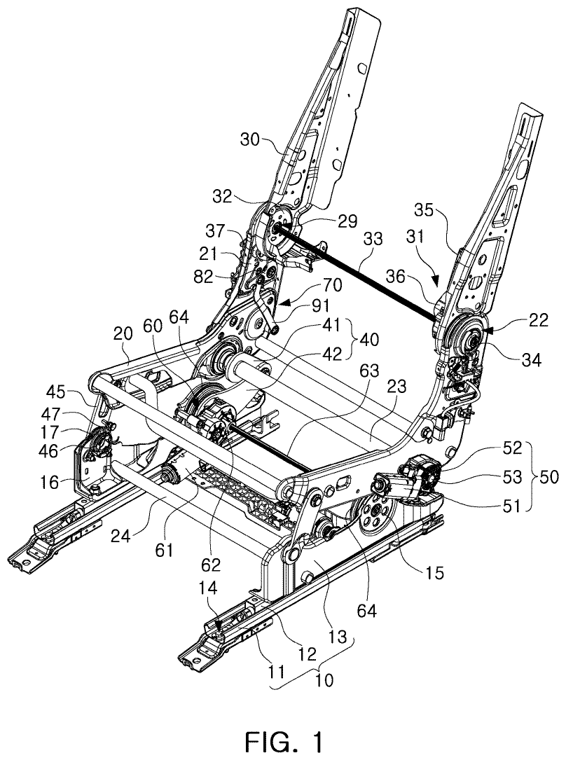

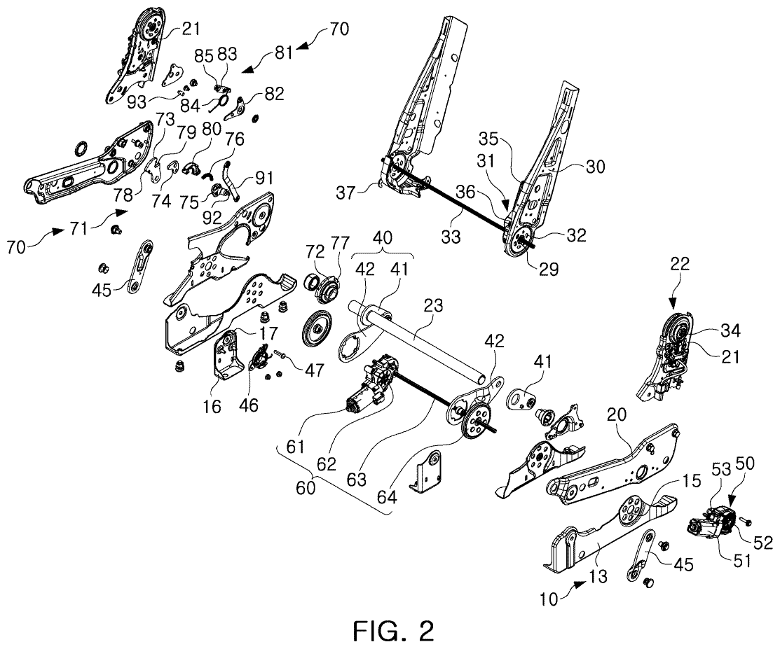

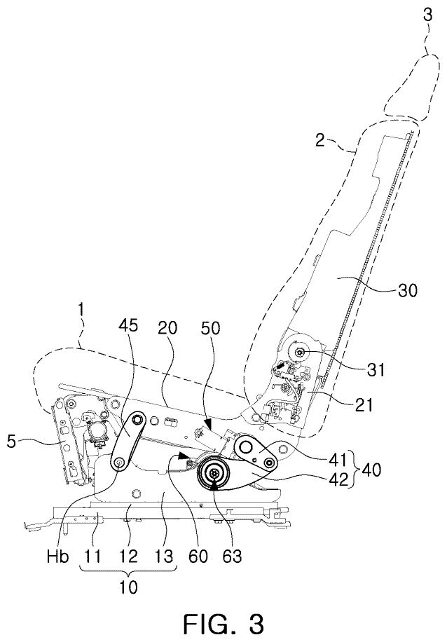

FIG. 1 is a partial perspective view showing an example of a seat for a vehicle to which the fold-and-dive apparatus, and FIG. 2 is an exploded perspective view illustrating the fold-and-dive apparatus. In addition, FIG. 3 is a side view of FIG. 1 and is a diagram illustrating a reference posture of an operation of a seat.

In some implementations, the seat for a vehicle may include a seat cushion 1 for seating a lower body, a seat back 2 for leaning an upper body, and a headrest 3 for supporting the head and neck. However, for convenience of illustration and explanation, detailed drawings and detailed description will be omitted.

In some implementations, in the seat for a vehicle, a leg rest 5 may be disposed in front of the seat cushion 1. The leg rest may be provided with a predetermined support surface capable of supporting a leg (calf) portion of an occupant.

The leg rest 5 may be configured to allow angle adjustment regardless of the seat cushion 1 or the seat back 2. In other words, the leg rest may be independently unfolded or folded using a separate power source, regardless of an inclination angle and height adjustment of the seat cushion. An operation of the leg rest only needs to not interfere with or not interrupt the operation of the seat cushion.

Since leg rests with various configurations are known in the art to which the present disclosure pertains, detailed descriptions thereof will be omitted in this specification.

As illustrated in FIGS. 1 to 3, the fold-and-dive apparatus may include a pair of bases 10, a pair of cushion side frames 20, a back frame 30, and a link assembly 40, a first driver 50, and a locking assembly 70.

The pair of bases 10 may be disposed side by side to be spaced apart from each other on a floor panel in the interior of a vehicle. For example, each base may include a seat rail 11 fixedly mounted on the floor panel, a moving rail 12 mounted on the seat rail to slide back and forth in a longitudinal direction of the seat rail, and a bracket 13 mounted on the moving rail.

The seat rail 11 may be fixedly mounted on the floor panel. A long open passage 14 may be formed in the seat rail for the moving rail 12 to slide back and forth. The open passage may form a path for sliding movement of the moving rail.

The moving rail 12 may slide along the open passage 14 of the seat rail 11. The moving rail may be configured as a manual type-moving rail which is operated by manipulating a tower bar, and an electric-type moving rail which is operated by receiving power from a motor by manipulating a switch. Since the configuration and operational relationship of the moving rail are known in the art to which the present disclosure pertains, detailed descriptions thereof will be omitted in this specification.

The bracket 13 may be formed with a hinge hole 15 or a hinge portion for connecting the link assembly 40 and a link arm 45, to be described later, and may be further provided with an auxiliary bracket 16, or the like.

The pair of bases 10 configured as described above may be installed at least partially to be able to slide back and forth in the longitudinal direction to support a bottom portion of the seat. However, the configuration and operational relationship of the base are not necessarily limited thereto, and for example, a fixed base may be employed.

Each of the pair of cushion side frames 20 may be disposed on the base 10 and placed side by side with each other, and support a cushion panel configured to support a load of an occupant therebelow. The pair of cushion side frames may be connected to each other by at least one cross bar 23.

The cross bar 23 is a member connecting and supporting a pair of left and right cushion side frames 20 in left and right directions, and may be disposed on at least one of the front and rear sides of the seat. The cross bar may be formed as a tubular member with a circular cross-section, but the configuration thereof is not necessarily limited thereto.

In some examples, at least one auxiliary cross bar 24 may be interposed to connect and support the pair of left and right bases 10 in the left and right directions. For example, FIG. 1 illustrates an example in which one auxiliary cross bar is disposed at the front of the base, but the number and disposition of auxiliary cross bars are not necessarily limited thereto.

In some implementations, a connection bracket 21 may be mounted at the rear of the pair of cushion side frames 20. A hinge portion 22 may be formed on the connection bracket to connect a back frame 30 of the seat back. In addition, a hinge hole 29 may be formed in a lower portion of the back frame. For example, a bush 34 may be fixedly coupled to the hinge portion of the connection bracket and rotatably coupled to the hinge hole of the back frame.

The back frame 30 may be rotatably connected to the pair of cushion side frames 20 via a recliner assembly 31 at the rear of the pair of cushion side frames 20. The back frame may constitute a seat back supporting the upper body of the occupant.

A recliner assembly 31 may be disposed at a connection point between the connection bracket 21 of the cushion side frame 20 and the lower end portion of the back frame 30, to appropriately adjust an inclination angle of the seat back 2 relative to the seat cushion 1 by the recliner assembly.

For example, the recliner assembly 31 may include a recliner 32, a shaft 33, a motor 35, and a power transmission mechanism 36.

The recliner 32 may be installed to correspond to the hinge hole 29 in the back frame 30. The recliner may substantially rotate the seat back 2 relative to the seat cushion 1, to adjust an inclination angle of the seat back relative to the seat cushion back and forth. Since recliners with various configurations are known in the art to which the present disclosure pertains, detailed descriptions thereof will be omitted.

The shaft 33 may be disposed to be elongated in the left and right directions of the seat. Both ends of the shaft 33 may respectively penetrate the hinge hole 29 of the back frame 30 and may be fixed to the hinge portion 22 of the connection bracket 21.

For example, the shaft 33 may be coaxially coupled to the bush 34. An external spline may be formed on a surface of the shaft by cutting grooves. The bush may be formed with an internal spline which is fitted and coupled to a spline of the shaft. Accordingly, the shaft may be fixed to the connection bracket 21 and the cushion side frame 20 through the bush.

In addition, the shaft 33 may pass through the recliner 32 and may be connected to the recliner, so that the recliner may be converted into a reclining locking state in which the seat back 2 is fixed at a predetermined angle due to the rotation of the shaft and a reclining unlocking state in which rotation thereof may be performed.

The motor 35 may be fixedly installed on the back frame 30 and may output rotational force through a motor shaft. For example, the motor may be fixed to a lower portion of the back frame so that the motor shaft is disposed vertically.

The power transmission mechanism 36 may transmit the rotational force output from the motor shaft of the motor 35 to the shaft 33. To this end, the power transmission mechanism may be disposed between the motor shaft of the motor and the shaft.

For example, when the motor shaft of the motor 35 and shaft 33 are disposed approximately at a right angle to each other, the power transmission mechanism 36 may include a worm shaft and a worm wheel to transmit rotational force from the motor shaft of the motor to the shaft and may be slowed down. At least one gear may further be interposed between the worm wheel and the shaft.

The motor 35 is driven in response to a user request, that is, a switch operation, and the motor shaft of the motor may rotate. For example, the power of the motor may be transmitted to the worm wheel through the motor shaft and the worm shaft, so that the shaft 33 may rotate relative to the back frame 30.

In a state in which the shaft 33 is fixed to the connection bracket 21, when rotational force is input from the motor shaft of the motor 35 to the shaft, the motor may rotate around the shaft. Since the motor is fixed to the back frame 30, the seat back 2 may rotate around the bush 34 with respect to the seat cushion 1.

Due to the rotation of the shaft 33, the recliner 32 may be operated to increase or decrease an inclination angle of the seat back 2 with respect to the seat cushion 1. By the recliner assembly 31 using the motor 35, the vehicle seat may become a so-called power seat.

However, the configuration and operational relationship of the recliner assembly 31 are not necessarily limited thereto. For example, when a manual recliner assembly is adopted, and when reclining locking of the recliner 32 is released, that is, in an unlocked state, an inclination angle of the back frame 30 may also be adjusted manually by an occupant.

In some implementations, a hook 37 acting as a trigger to release the dive locking of the locking assembly 70 may be fixedly mounted in a lower end portion of the back frame 30. The hook may be disposed around the hinge hole 29 of the back frame, and may have a predetermined orientation around the shaft 33 penetrating through the hinge hole of the back frame.

When the seat back 2 is folded, the hook 37 rotates with the back frame 30 and is locked and fixed to the locking assembly 70 at a predetermined angular displacement, thereby allowing the hook to release the dive locking of the locking assembly. The connection relationship and linkage of the hook will be described later.

The link assembly 40 may be respectively disposed on both left and right sides of the seat. In other words, the link assembly is provided as a pair, one link assembly may be disposed between a base 10 on one side of the left and right sides of the seat and the cushion side frame 20, and the other link assembly may be disposed between a base on the other side of the left and right sides of the seat and the cushion side frame.

The link assembly 40 may connect the base 10 and the cushion side frame 20 at the rear of the seat. For example, the link assembly may include a first link member 41 and a second link member 42.

One end of the first link member 41 may be rotatably hinged to the cushion side frame 20, and the other end of the first link member may be rotatably hinged to one end of the second link member 42 relative to each other. In addition, the other end of the second link member may be rotatably hinged to the bracket 13 of the base 10.

In some implementations, a link arm 45 connecting the base and the cushion side frame may be disposed between the base 10 and the cushion side frame 20 at the front of the seat. One end of the link arm may be rotatably hinged to the cushion side frame, and the other end of the link arm may be rotatably hinged to the bracket 13 of the base.

In some examples, a return spring 46 may be mounted on at least one of the hinge portions at both ends of the link arm 45 to help the link arm return after the rotation. To this end, for example, one end of the return spring may be fixed to a protrusion 17 formed on the bracket 13 of the base 10, and the other end of the return spring may be fixed to a fixing pin 47 provided on the link arm. A torsion spring may be employed as a return spring, but the present disclosure is not necessarily limited thereto.

For example, when the seat is returned to the reference posture shown in FIG. 3 after the link arm 45 is rotated for arbitrary posture of the seat, the link arm rotates smoothly by restoring force of the return spring 46, along with the driving force of the first driver 50, thereby ensuring stable return performance of the seat.

In the seat for a vehicle to which the fold-and-dive apparatus is applied, the base 10, the link arm 45, the cushion side frame 20, and the first link member 41 and the second link member 42 of the link assembly 40 may be hingedly connected to each other to form a five-bar linkage mechanism.

A first driver 50 providing rotational force may be installed in the link assembly 40 to adjust the inclination angle and/or height of the cushion side frame 20 with respect to the base 10.

For example, when the link assembly 40 includes a first link member 41 and a second link member 42, the first driver 50 may be connected to at least the first link member. As shown in FIGS. 1 to 3, the first driver may be mounted on an outer surface of one of the pair of cushion side frames 20, for example, by bolting.

Although the first driver 50 is mounted only on one of the pair of cushion side frames 20, the pair of left and right cushion side frames and one end of the first link members 41 on both sides are connected to each other by a cross bar 23, so that when the inclination angle and/or height of one cushion side frame is adjusted, the inclination angle and/or height of the other cushion side frame may also be synchronously adjusted in the same manner.

The first driver 50 may include a first driving motor 51, a first gearbox 52 connected to a motor shaft of the first driving motor, and an output shaft 53 of the first gearbox.

The first gearbox 52 may include, for example, a worm shaft installed on the motor shaft of the first drive motor 51, a worm wheel engaged with an outer peripheral surface of the worm shaft, and an output shaft 53 connected to the worm wheel. However, the configuration of the first gearbox is not necessarily limited thereto.

The output shaft 53 may be connected to one end of the first link member 41 via a cross bar 23 through the cushion side frame 20, thereby acting as a hinge shaft.

For example, as shown in FIG. 1, one cross bar 23 may be located at the rear of the seat between the pair of left and right cushion side frames 20 on both sides. Both ends of the cross bar may penetrate each of the pair of cushion side frames and be coupled to the pair of cushion side frames to enable relative rotation with respect to the cushion side frame, and one end of the cross bar may be fixedly coupled to the output shaft 53 of the first gearbox 52 through a spline, bush, or the like.

In this case, an end of the cross bar 23 may be fixed to one end of the first link member 41. For example, the end of the cross bar may penetrate through the first link member, and the cross bar and the first link member may be integrally fixedly coupled to each other by welding or the like.

Accordingly, the cross bar 23 fixed to the output shaft 53 of the first gearbox 52 may rotate by receiving the rotational force of the first driving motor 51, and the first link member 41 fixed to the cross bar may rotate relative to the cushion side frame 20 around the cross bar and the output shaft.

At the same time, due to the rotation of the first link member 41, the second link member 42 rotatably hinged to the base 10 may rotate relative to the first link member. In addition, along with the rotation of the first link member, the cross bar 23 rotates and moves vertically.

Due to the vertical movement of the cross bar 23, the pair of cushion side frames 20 on both sides move vertically, and thus the seat cushion 1 and the entire seat may move vertically, so that the height may be adjusted, or tilting of the seat cushion may be adjusted.

This first driver 50 allows the fold-and-dive mode to be executed in the seat for a vehicle to which the fold-and-dive apparatus is applied.

In some examples, the fold-and-dive apparatus may further include a second driver 60 connected to the second link member 42 of the link assembly 40 to provide rotational force.

As shown in FIGS. 1 and 2, the second driver 60 may be mounted on an inner surface of a bracket 13 of one of the pair of bases 10 disposed on both left and right sides of the seat, for example, by bolting.

The second driver 60 may include a second driving motor 61, a second gearbox 62 connected to a motor shaft of the second driving motor, a connection shaft 63 connected to an output side of the second gearbox, and a pair of cores 64 respectively coupled to both ends of the connection shaft.

The second gearbox 62 may include, for example, a worm shaft installed on the motor shaft of the second driving motor 61, a worm wheel engaged with an outer peripheral surface of the worm shaft, and an output gear connected to the worm wheel, and the connection shaft 63 may be connected to the output gear. However, the configuration of the second gearbox is not necessarily limited thereto.

The connection shaft 63 is fixedly connected to the other end of the second link member 42 via the core 64, so that the connection shaft 63 may act as a hinge shaft. In addition, an external spline may be formed on the outer peripheral surface of the connecting shaft and be engaged with an internal spline formed on the output gear in the second gearbox, so that the connection shaft may transmit the rotational force of the second driving motor 61 to the second link member.

The pair of cores 64 may be formed in a plate shape having an approximately predetermined thickness and may be fixedly coupled to both ends of the connection shaft 63 so as not to rotate relative to each other. A second link member 42 may be fixedly coupled to one side of the core, for example, to a side surface inwardly of the seat, and a stepped portion formed on the other side of the core, for example, to a side surface outwardly of the seat may be rotatably connected to the hinge hole 15 formed in the bracket 13 of the base 10.

Such a core 64 may be applied to be fixed to the hinge portion of the second link member 42 in the link assembly 40, so that when the link assembly is fixed thereto without being rotated, the core 64 may act as a restraining apparatus configured to secure the strength of the link assembly and prevent the link assembly from moving forward and backward.

As a result, the rotational force of the second driving motor 61 is transmitted to the second link member 42 through the second gearbox 62 and the connection shaft 63, so that the second link member may rotate relative to the base 10. At the same time, due to the rotation of the second link member, the first link member 41 connected to the cushion side frame 20 rotates relative to the second link member.

In the seat for a vehicle to which the fold-and-dive apparatus is applied, the second driver 60 may execute not only a fold-and-dive mode, but also other arbitrary modes, for example, a relaxation mode and/or tilt up walk-in mode.

The locking assembly 70 may be interposed between the back frame 30 and the first driver 50 to restrict the operation of the first driver or release the restriction thereof. To this end, the locking assembly may include a dive lock 71 installed on the cushion side frame 20 opposite to the first driver to restrict the rotation of the cross bar 23; a releaser 81 installed on the connection bracket 21 of the corresponding cushion side frame and linked to the folding of the back frame to unlock the dive lock; and a connection bar 91 connecting the operation of the releaser and the operation of the dive lock.

The dive lock 71 may include a dive holder 72, a tooth bracket 73, a cam lever 74, a pin plate 75, and a first spring 76.

The dive holder 72 is a substantially ring-shaped disk, and may be integrally fixedly coupled to the other end of the cross bar 23 through welding or the like. A ratchet groove 77 may be formed on a circumferential surface of the dive holder.

The tooth bracket 73 may have a tooth-shaped portion 78 formed on one side and a cam groove 79 formed on the other side, and may be rotatably hinged to the cushion side frame 20. The tooth-shaped portion of the tooth bracket may be locked by the ratchet groove 77 of the dive holder 72, so that the rotation of the cross bar 23 and the operation of the first driver 50 may be restricted.

The cam lever 74 may be disposed to be adjacent to the tooth bracket 73 on the opposite side of the tooth-shaped portion 78, i.e. closer to the cam groove 79, and may be rotatably hinged to the cushion side frame 20. The cam surface of the cam lever may contact the tooth bracket to keep the tooth bracket from rotating or apply force to rotate the tooth bracket.

The pin plate 75 may be rotatably assembled on the same hinge shaft as the cam lever 74, and may rotate together with the cam lever. One end of the first spring 76 may be fixed to one side of the pin plate, and a connection pin 92 may be formed on the other side of the pin plate to be hinged to one end of the connection bar 91.

The first spring 76 may provide the cam lever 74 with an elastic force returning the cam lever after the rotation of the cam lever. To this end, one end of the first spring may be fixed to one side of the pin plate 75, and the other end of the first spring may be fixed to the cushion side frame 20 or a spring holder 80 coupled to the cushion side frame. A coil spring may be employed as the first spring, but the present disclosure is not necessarily limited thereto.

This dive lock 71 may be configured so that the cam surface of the cam lever 74 contacts the tooth bracket 73 to keep the tooth bracket from rotating, the tooth-shaped portion 78 of the tooth bracket is locked by the ratchet groove 77 of the dive holder 72, and therefore, the rotation of the cross bar 23 and the operation of the first driver 50 may be restricted.

The releaser 81 may include a release lever 82, a locking bracket 83, and a second spring 84.

The release lever 82 is a member formed in an approximately L-shape, and may be rotatably hinged to the connection bracket 21 of the cushion side frame 20. A connection pin 93 may be formed on one side of the release lever and may be hinged to the other end of the connection bar 91.

The locking bracket 83 may be hinged to the other side of the release lever 82 and may rotate relative to the release lever. One end of the second spring 84 may be fixed to one side of the locking bracket, and a locking pin 85 may be formed on the other side so that the hook 37 of the back frame 30 may be locked.

The second spring 84 may provide elastic force to the locking bracket 83 to return the release lever 82 after rotation. To this end, one end of the second spring may be fixed to one side of the locking bracket, and the other end may be fixed to the connection bracket 21. A torsion spring may be employed as the second spring, but the present disclosure is not necessarily limited thereto.

In some implementations, the seat for a vehicle may include a switch installed to input an occupant request, and a control unit installed to control the operation of the driving motors 51, 61 and/or the motor 35 according to the switch operation.

The control unit may control the operations of the motor 35 comprising the recliner assembly 31, the first driving motor 51 comprising the first driver 50, and the second driving motor 61 comprising the second driver 60, based on the occupant's switch operation. Here, as the motor, the first and second driving motors, for example, a servo motor or a step motor capable of forward and reverse rotation may be employed.

Hereinafter, the operation of the seat for a vehicle to which the fold-and-dive apparatus, which has the above-described configuration, is applied will be described.

First of all, the seat for a vehicle may basically implement forward and backward modes.

For example, when the electric type moving rail 12 is adopted, as shown in FIG. 3, in a state in which the seat for a vehicle maintains the reference posture, the motor may drive in response to the occupant request, that is, the switch operation, and the driving force of the motor may be transmitted to the moving rail via an arbitrary power transmission mechanism, so that the moving rail may move relative to the seat rail in a longitudinal direction of the seat rail 11.

In this case, the cushion side frame 20 connected to the moving rail 12 may move together, so that the seat cushion 1 and the entire seat to may move forwards or backwards to adjust the front and rear positions of the seat.

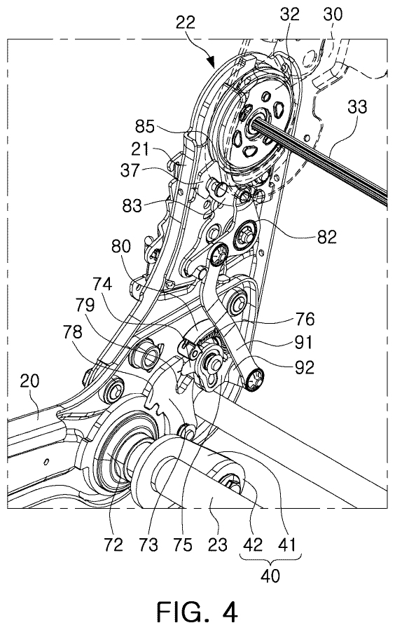

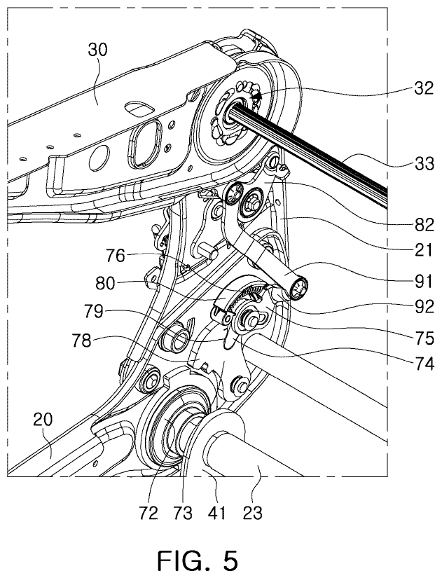

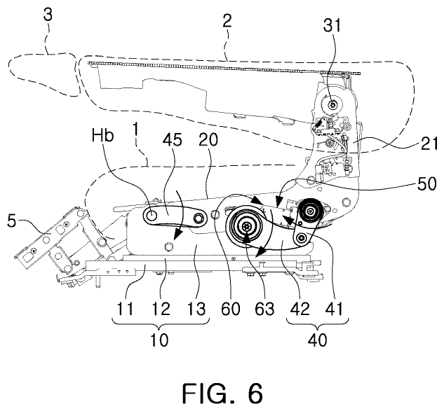

FIGS. 4 and 5 are diagrams illustrating an operation of a fold-and-dive apparatus, and FIG. 6 is a side view illustrating a state in which a seat back of a seat is folded by the fold-and-dive apparatus.

In a seat for a vehicle to which the fold-and-dive apparatus is applied, when a seat back 2 is folded, the seat back may be flattened and a seat cushion 1 may be lowered.

In response to the occupant request, that is, an operation of a switch, a control unit may control an operation of a first driving motor 51 comprising a first driver 50, along with a motor 35 of a recliner assembly 31.

The recliner assembly 31 operates to fold the seat back 2. Specifically, the motor 35 drives, and a motor shaft of the motor rotates in one direction.

In a state in which the shaft 33 is fixed to the connection bracket 21, when rotational force is input from the motor shaft of the motor 35 to the shaft through the power transmission mechanism 36, for example, a worm shaft and a worm wheel, the motor rotates around the shaft. Since the motor is fixed to the back frame 30, the seat back 2 rotates around the bush 34 with respect to the seat cushion 1.

The recliner 32 operates due to the rotation of the shaft 33, to reduce the inclination angle of the seat back 2 with respect to the seat cushion 1, and thus the seat back may be folded almost horizontally from the reference posture of the seat for a vehicle shown in FIG. 3.

When the seat back 2 is folded, a hook 37 rotates together with the back frame 30 and is locked by a locking pin 85 of a locking bracket 83 comprising a releaser 81 of the locking assembly 70 at a predetermined angular displacement, and the hook allows dive locking of the locking assembly to be released.

Specifically, in FIG. 4, when the hook 37 is locked by the locking pin 85 and the back frame 30 rotates around the shaft 33, the locking pin moves together with the hook toward the rear side. Accordingly, the locking bracket 83 moves backwards, and the release lever 82 hinged to the locking bracket rotates in a first direction (clockwise in FIG. 4) and simultaneously pulls the connection bar 91 upwardly to be raised.

Due to the rise of the connection bar 91, the pin plate 75 of the dive lock 71 rotates in a second direction (counterclockwise in FIG. 4), and the cam lever 74 assembled on the pin plate also rotates in the second direction. Accordingly, as shown in FIG. 5, the cam surface may be inserted into the cam groove 79 of the tooth bracket 73 so that the tooth bracket may be rotated in the first direction.

As the tooth bracket 73 rotates, the tooth-shaped portion 78 of the tooth bracket deviate from the ratchet groove 77 of the dive holder 72, and thus the dive locking by the dive lock 71 is released. Therefore, the rotation of the cross bar 23 and the operation of the first driver 50 may be performed.

Subsequently, the first driving motor 51 of the first driver 50 connected to the first link member 41 of the link assembly 40 is driven, and the motor shaft of the first driving motor rotates in one direction.

Accordingly, the rotational force of the first driving motor 51 is transmitted to the first link member 41 through the first gearbox 52 and the output shaft 53, and the first link member rotates in the first direction (clockwise in FIG. 6) around the output shaft in the cushion side frame 20, and at the same time, a rear portion of the cushion side frame is raised upwardly.

Due to the rotation of the first link member 41, both cushion side frames 20 move backwards. As the cushion side frame moves, the link arm 45 rotates in the first direction around a hinge point Hb on the bracket 13 of the base 10, and at the same time lowers a front portion of the cushion side frame downwardly.

In some examples, the second driver 60 may operate. In other words, the second driving motor 61 drives, and the motor shaft of the second driving motor 61 rotates in one direction.

Accordingly, the rotational force of the second driving motor 61 is transmitted to the second link member 42 through the second gearbox 62 and the connection shaft 63, so that the second link member rotates in the first direction around the connection shaft on the bracket 13 of the base 10, and at the same time a rear portion of the cushion side frame 20 is lowered downwardly.

Due to the rotation of the second link member 42 after the rotation of the first link member 41, both cushion side frames 20 are further moved backwards. As the cushion side frame moves, the link arm 45 further rotates in the first direction around the hinge point Hb of the bracket 13, and at the same time, the front portion of the cushion side frame is further lowered downwardly.

Finally, in the fold-and-dive mode, the height of the seat cushion 1 and the entire seat may be lower than the reference posture of the seat for a vehicle, shown in FIG. 3, and the front portion of the cushion side frame 20 will be relatively lower than the rear portion.

In some examples, when the leg rest 5 is disposed at the front of the seat cushion 1, the control unit may control a separate power source to independently unfold the leg rest.

As described above, in the seat for a vehicle to which the fold-and-dive apparatus is applied, there is an advantage in which dive locking may be automatically released according to the angular displacement when the seat back is folded, without manual operation or driving a separate unlocking device.

In addition, as the fold-and-dive device is linked to the five-bar linkage mechanism, the inclination angle of the cushion side frame 20 is changed, and the front and rear portions of the cushion side frame are lowered simultaneously, so that the seat back 2 may be substantially parallel to a horizontal plane and the height of the seat cushion 1 and the entire seat may be lowered.

Therefore, in a case in which such a seat for a vehicle is applied to a second row of seats in a vehicle with 6 or more seats, even if the protrusion of the bolster of the seat back increases, when the seat back 2 is folded in a fold-and-dive mode, there is an advantage that the seat back is almost flat and a step difference with a third row of seats may be eliminated.

For example, in the fold-and-dive mode, the seat back 2 may be tilted, for example, at an angle of 3 degrees with respect to the horizontal surface, so that the seat back 2 may be folded almost parallel to the horizontal surface.

By expanding a cargo loading space of the vehicle through flattening of the seat back, the seat for a vehicle to which the fold-and-dive apparatus is applied may improve loading performance of the vehicle and diversity uses of the cargo loading space.

As described above, in some implementations, even if the protrusion of the bolster of the seat back increases, the flatness of the folded seat back can be increased, thereby expanding the cargo loading space and increasing convenience along with the safety of vehicle occupants.

As set forth above, even when a protrusion of a seat back bolster increases, flatness of a folded seat back may be increased, thereby achieving an effect for expanding a cargo loading space and increasing convenience along with the safety of the occupants.

The aforementioned description merely illustrates the technical concept of the present disclosure, and a person skilled in the art to which the present disclosure pertains may make various modifications and modifications without departing from the essential characteristics of the present disclosure.

Therefore, the example embodiments disclosed in this specification and drawings are not intended to limit but to explain the technical concept of the present disclosure, and the scope of the technical idea of the present disclosure is not limited by these example embodiments. The scope of protection of the present disclosure should be interpreted by the following claims, and all technical ideas within the scope equivalent thereto should be interpreted as being included in the scope of the present disclosure.

What is claimed is:

1. A fold-and-dive apparatus, comprising:
a pair of bases disposed at a vehicle and spaced apart from each other in a left-right direction;
a left cushion side frame and a right cushion side frame that are connected to the pair of bases, respectively, wherein a position of the left and right cushion side frames is configured to change with respect to the pair of bases;
a recliner assembly disposed at a rear side of the left and right cushion side frames;
a back frame rotatably connected to the left and right cushion side frames based on operation of the recliner assembly;
a link assembly that is disposed at the rear side of the left and right cushion side frames and connects one of the pair of bases to one of the left and right cushion side frames;
a first driver connected to the link assembly and configured to provide rotational force to the link assembly; and
a locking assembly that is interposed between the back frame and the first driver and configured to restrict operation of the first driver.

2. The fold-and-dive apparatus of claim 1, further comprises at least one cross bar that connects the left and right cushion side frames to each other,
wherein the at least one cross bar has (i) a first end that passes through and is rotatably coupled to one of the left and right cushion side frames and (ii) a second end that passes through and is rotatably coupled to the other of the left and right cushion side frames, and
wherein one of the first and second ends of the at least one cross bar is coupled to an output shaft of the first driver.

3. The fold-and-dive apparatus of claim 2, wherein each of the left and right cushion side frames comprises a connection bracket connected to the locking assembly, and
wherein the locking assembly comprises:
a dive lock that is disposed at one of the left and right cushion side frames and configured to restrict rotation of the at least one cross bar;
a releaser disposed at the connection bracket of the one of the left and right cushion side frames, the releaser being configured to, based on a folding movement of the back frame, release a locking of the dive lock; and
a connection bar that associates an operation of the releaser with an operation of the dive lock.

4. The fold-and-dive apparatus of claim 3, wherein the dive lock comprises:
a dive holder fixed to the other of the first and second ends of the at least one cross bar, the dive holder defining a ratchet groove on a circumferential surface of the dive holder;
a tooth bracket rotatably coupled to one of the left and right cushion side frames, the tooth bracket comprising (i) a tooth-shaped portion disposed at a first side of the tooth bracket and configured to engage with the ratchet groove and (ii) a cam groove defined at a second side of the tooth bracket;
a cam lever disposed adjacent to the tooth bracket and disposed at an opposite side of the tooth-shaped portion, the cam lever being rotatably coupled to the one of the left and right cushion side frames, and having a cam surface in contact with the tooth bracket;
a pin plate rotatably disposed at a hinge shaft of the cam lever and configured to rotate with the cam lever, the pin plate comprising a connection pin that is disposed at a first side of the pin plate and hinged to a first end of the connection bar; and
a first spring having (i) a first end fixed to a second side of the pin plate and (ii) a second end fixed to the one of the left and right cushion side frames, and
wherein the tooth-shaped portion is configured to, based on the cam surface being inserted into the cam groove, deviate from the ratchet groove.

5. The fold-and-dive apparatus of claim 4, wherein the releaser comprises:
a release lever rotatably coupled to the connection bracket, the release lever comprising a connection pin disposed at a first side of the release lever and hinged to a second end of the connection bar;
a locking bracket rotatably coupled to a second side of the release lever, the locking bracket comprising a locking pin that is disposed at a first side of the locking bracket; and
a second spring having (i) a first end fixed to a second side of the locking bracket and (ii) a second end fixed to the connection bracket, and
wherein the fold-and-dive apparatus further comprises a hook that is disposed at a lower portion of the back frame, the hook being configured to, based on rotation of the back frame, be locked by the locking pin.

6. The fold-and-dive apparatus of claim 2, wherein the link assembly comprises a first link member and a second link member that are configured to rotate relative to each other,
wherein the first link member has (i) a first end rotatably coupled to one of the left and right cushion side frames and (ii) a second end rotatably coupled to a first end of the second link member, and
wherein a second end of the second link member is rotatably coupled to the one of the pair of bases.

7. The fold-and-dive apparatus of claim 6, wherein the first driver comprises:
a first driving motor;
a first gearbox connected to a motor shaft of the first driving motor; and
the output shaft, and
wherein the output shaft is connected to the first end of the first link member via the at least one cross bar.

8. The fold-and-dive apparatus of claim 6, further comprising:
a second driver connected to the second link member and configured to provide rotational force to the second link member, the second driver being disposed at the one of the pair of bases.

9. The fold-and-dive apparatus of claim 8, wherein the second driver comprises:
a second driving motor;
a second gearbox connected to a motor shaft of the second driving motor;
a connection shaft connected to the second gearbox; and
a pair of cores coupled to ends of the connection shaft, respectively, and
wherein the connection shaft is fixed to the second end of the second link member via one of the pair of cores.

10. The fold-and-dive apparatus of claim 6, further comprising:
a link arm that connects the one of the pair of bases to the one of the left and right cushion side frames, the link arm being disposed at a front side of the one of the left and right cushion side frames, and
wherein the one of the pair of bases, the link arm, the one of the left and right cushion side frames, the first link member, and the second link member are hinged to one another and define a five-bar linkage mechanism.

11. The fold-and-dive apparatus of claim 10, wherein the link arm has (i) a first end rotatably coupled to the one of the left and right cushion side frames and (ii) a second end rotatably coupled to the one of the pair of bases, and
wherein the fold-and-dive apparatus further comprises a return spring that is configured to cause the link arm to return after a rotation of the link arm, the return spring being disposed at at least one of hinge portions that are disposed at the first and second ends of the link arm.

12. The fold-and-dive apparatus of claim 1, wherein each of the pair of bases comprises:
a seat rail fixed to the vehicle;
a moving rail disposed at the seat rail and configured to move back and forth along a longitudinal direction of the seat rail; and
a bracket disposed at the moving rail, and
wherein the bracket is formed with a hinge hole or a hinge portion for connecting the link assembly.
